(19) United States
(12) Patent Application Publication
(10) Pub. No.: US 2005/0260490 A1
(43) Pub. Date: Nov. 24, 2005

(54) Adhesive-treated electrode separator and method of adhering an electrode thereto

(76) Inventors: Luigi Persi, Cernobbio (IT); Martin VanBuren, Chelmsford, MA (US); Denis G. Fauteux, Deerfield Beach, FL (US)

Correspondence Address: FACTOR & LAKE, LTD, 1327 W. WASHINGTON BLVD., SUITE 5G/H, CHICAGO, IL, 60607, US

(21) Appl. No.: 10/850,353

(22) Filed: May 19, 2004

(51) Int. Cl. H01M 2/16; H01M 2/18

(52) U.S. Cl. 429/144; 429/254; 29/623.4

(57) ABSTRACT

An adhesive-treated porous separator and a method of adhering an electrode to the adhesive-treated separator without substantially occluding the pores of the separator. The adhesive-treated separator membrane comprises a porous separator having an anode side and a cathode side, a first adhesive formulation coated on the anode side, and a second adhesive formulation coated on the cathode side. The first and second adhesive formulations each include an adhesive component, a solvent, and an occlusion prevention component. The method of adhering the electrode to the adhesive-treated separator includes the steps of providing the first adhesive formulation and the second adhesive formulation, providing a porous separator having an anode side and a cathode side; coating the anode side of the separator with the first adhesive formulation and coating the cathode side of the separator with the second adhesive formulation such that the occlusion prevention component substantially fills the pores of the separator; precluding occlusions in the pores of the separator so as to substantially free the pores of occlusions; and laminating an anode to the anode side and a cathode to the cathode side of the separator.

### TECHNICAL FIELD

The present invention relates generally to an adhesive-treated separator and a method for adhering an electrode to the adhesive-treated separator in a lithium ion electrochemical cell without substantially occluding the pores of the separator.

### BACKGROUND OF THE INVENTION

Lithium ion electrochemical cells are known in the art. Such cells or batteries generally include an electrolyte, an anode, and a cathode. During fabrication of the cell, the anode and cathode are adhered to or are otherwise brought into contact with a separator. The quality of the electrodes' adhesion or contact with the separator has a significant impact on battery performance. For example, poor adhesion or contact of the electrodes to the separator may negatively affect the electrical continuity of the cell, increase resistance within the cell, or may reduce the number of possible geometries the cell can be formed into. There are a number of known methods for adhering or adjoining electrodes to a separator, all of which have deficiencies.

In known liquid electrolyte systems, while the ionic conductivity is excellent, there is little, if any, adhesion between the separator and the electrodes. Consequently, in order to achieve satisfactory contact between the separator and the electrodes, mechanical constraints are often used, either by winding under tension or by stacking under pressure. These methods, in particular, limit the geometric shapes of the batteries that can be manufactured.

In gel-polymer electrolyte separator membrane systems, a gel-polymer that includes a liquid electrolyte is generally soaked into a porous separator membrane. The polymeric gel electrolyte enhances the adhesive properties of the separator membrane while the porous separator provides mechanical support for the polymeric gel electrolyte. In such systems, while the adhesion between the electrodes and the electrolyte separator membrane is satisfactory, the ionic conductivity is poor in comparison to liquid electrolyte systems, and is also too low to permit satisfactory battery performance at sub-ambient temperatures and at sustained high rates of discharge.

One particular cause of this poor ionic conductivity is the filling of pores in the porous separator membrane by the polymeric component of the gel-polymer electrolyte when it is applied to the separator membrane. This filling of the pores reduces the void fraction of the porous separator membrane available for the liquid component of the gel-polymer electrolyte. This, in turn, reduces the conductivity of the system and is detrimental to battery performance. Additionally, this filling of the pores by the polymer component of the gel-polymer electrolyte necessitates an increase in the amount of the polymer component to achieve satisfactory adhesion of the electrodes to the separator membrane. This increase of polymer component generally adds to the cost, reduces performance and also results in higher rates of defects during the manufacturing process.

Therefore, it would be advantageous to provide an adhesive-treated separator and a method for adhering an electrode to the adhesive-treated separator without substantially occluding the pores of the separator in the fabrication of a lithium ion liquid electrolyte cell so as to enable the production of free-form batteries having various geometries (including accordion fan-fold geometries) with improved performance (as compared to gel polymer electrolyte or with equivalent performance as compared to liquid electrolyte cells).

### SUMMARY OF THE INVENTION

The present invention is an adhesive-treated separator without substantially occluded pores and a method for adhering an electrode to the adhesive-treated separator without substantially occluding the pores of the separator in the fabrication of a lithium ion liquid electrolyte cell so as to enable the production of free-form batteries having various geometries (including accordion fan-fold geometries) with improved performance.

The adhesive-treated separator and method of adhering the electrode to the separator enable the formation of liquid electrolyte electrochemical cells having numerous improvements over the known art. The adhesive-treated separator includes an adhesive formulation which enables the fabrication of electrochemical cells having a high level of registration, low rates of mechanical and thermal deformations, smoother contact between electrode and separator, lower resistance, and increased efficiency. Further, the resulting anode/separator/cathode laminates are thin and easily foldable into configurations such as a fan fold which maximize battery surface area.

The adhesive treated separator membrane comprises a porous separator having an anode side and a cathode side. A first adhesive formulation is coated on the anode side and a second adhesive formulation is coated on the cathode side. The first and second formulations may be of substantially similar composition, or alternatively may be of a different composition to optimize adhesive properties required for each electrode. Additionally, the adhesive formulations may also be coated on the separator membrane with a substantially similar coating thickness or a different coating thickness on each side.

The adhesive formulations each include an adhesive component, a solvent, and an occlusion prevention component. The adhesive is selected from the group consisting of ionomers, poly(ethylene-co-methyl-acrylate), poly(methyl methacrylate), polyethylene oxide, polyvinylidene fluoride, and polyvinylidene fluoride-hexafluoropropene. Preferably, each adhesive formulation includes between one and three weight-percent of the adhesive component. In one embodiment, the adhesive component of at least one of the first and second adhesive formulations includes at least two components, wherein one component (first component) promotes adhesion of an electrode to the separator and the other component (second component) promotes ionic conductivity. The second component is not necessarily an adhesive, as in the cited case of ethylene carbonate. Ethylene carbonate is a particularly suitable second component because it is solid at ambient temperature and compatible with liquid electrolyte formulation. Any low vapor pressure liquid electrolyte components could be used, such as, for example, propylene carbonate. It is preferable to use a low vapor pressure liquid so it does not evaporate during the coating process and subsequent storage. This second component promotes adhesion since it will melt during the heat lamination step thus making the polymer component tacky. It also prevents occlusion since it becomes a part of the liquid electrolyte after the cell is completely assembled and filled with the liquid electrolyte.

The solvent is selected from the group consisting of acetone and tetrahydrofuran.

Preferably, the adhesive is substantially insoluble in the solvent so as to precipitate the adhesive component onto a surface of the separator. However, the polymer component of the adhesive could be soluble in the liquid electrolyte since adhesion is necessary mainly during the assembly process and less necessary after the cell is completed and the liquid electrolyte has been added.

The occlusion prevention component may be a solid or liquid at ambient temperature. Preferably, the melting point of the occlusion prevention component is in the range of 20° to 30° C. such that the occlusion prevention component can be melted to substantially free the pores of the separator of occlusions at a temperature unlikely to cause thermal stress to the resulting cell.

In yet another embodiment, the occlusion prevention component is a liquid at ambient temperature and may include a solvent selected from the group consisting of γBL, diethyl carbonate, dimethyl carbonate, ethylene carbonate, and propylene carbonate. The adhesive component is preferably substantially insoluble in the solvent so as to precipitate the adhesive component onto a surface of the separator.

Additionally, the first and second formulations may further include a performance enhancing additive, such as vinyl carbonate, 1,6-spirodilactone and succinic anhydride and phosphate based flame retardant component for increased battery safety.

In a preferred embodiment, the adhesive-treated separator is part of a lithium ion liquid electrolyte electrochemical cell which includes the adhesive-treated separator membrane as described above, an anode associated with the anode side of the separator via the first adhesive formulation, a cathode associated with the cathode side of the separator via the second adhesive formulation, and a liquid electrolyte component to enable electrolyte conductivity between the anode and electrode. The liquid electrolyte preferably includes a lithium salt selected from the group consisting of LiPF6, LiClO4, LiAsF6, and LiBF4.

In one embodiment, the occlusion prevention component is chemically and electrochemically inert with respect to the electrochemical cell. In another embodiment, the occlusion prevention component melts to become a component usable in the electrochemical cell such as a lithium ion liquid electrolyte.

Due to the reduced thicknesses of cells fabricated by the present invention, the electrochemical cell can be laminated and formed into a free form cell having any desirable shape, such as a zig-zag formation, any polygonal shape, or any prismatic form. In one embodiment, the resulting laminated electrochemical cell has a capacity ratio of 0.88-0.96 at 1C/0.2C and a capacity ratio of 0.71-0.86 at 2C/0.2C. In another embodiment, the resulting electrochemical cell has an internal resistance of less than 40 ohms².

The present invention further includes a method for adhering the adhesive-treated separator membrane in a lithium ion liquid electrolyte electrochemical cell without substantially occluding the pores of the separator. The method comprises the steps of:

a) providing a first adhesive formulation and a second adhesive formulation, wherein the first and second adhesive formulation each include an adhesive component, a solvent, and an occlusion prevention component;

b) providing a porous separator having an anode side and a cathode side;

c) coating the anode side of the separator with the first adhesive formulation and coating the cathode side of the separator with the second adhesive formulation such that the occlusion prevention component substantially fills the pores of the separator;

d) precluding occlusions in the pores of the separator such that the pores of the separator are substantially free of occlusions; and

e) laminating an anode to the anode side and a cathode to the cathode side of the separator.

In the above method, the first and second adhesive formulations are coated on the separator by spraying, a micro-gravure process, dip coating, or any other suitable means. During the coating step, the occlusion prevention component of each adhesive formulation substantially plugs the pores of the separator and substantially prevents the adhesive component from filling the same pores. Because the pores of the separator are substantially blocked by the occlusion prevention component, the insoluble adhesive is maintained on the surface of the separator where it can most efficiently come into contact with the electrodes to be adhered. When the occlusion prevention component is removed via melting or evaporating, preferably during the lamination step, the pores become substantially free of occlusions. Thus, in a closed electrochemical cell, ions may efficiently pass through the separator pores while the bulk of the adhesive is maintained outside the pores. Thus, the adhesive-treated separator membrane and method for adhering an electrode to the separator reduce the amount of adhesive required, maximize electrode efficiency, and enable the production of free form batteries which maximize surface area.

### BRIEF DESCRIPTION OF THE DRAWINGS

FIG. 1 of the drawings is a cross-sectional view of the present invention.

FIG. 2 of the drawings is a top, perspective view of the present invention showing the occlusion prevention component filled in the pores of the separator.

FIG. 3 of the drawings is a top, perspective view of the present invention showing the pores of the separator substantially free of occlusions.

FIG. 4 of the drawings is a perspective view of the electrode assembly of the present invention.

FIG. 5 of the drawings is a side, elevated view of the electrode assembly of the present invention.

FIG. 6 of the drawings is a cross-sectional view of the electrode assembly of the present invention.

FIG. 7 of the drawings is a cross-sectional view of the electrode assembly of the present invention.

FIG. 8 is a graph displaying the effect of PEO concentration on Rate Capability at 1C/0.2C for EXAMPLE 1 of the present invention.

FIG. 9 is a graph displaying the effect of PEO concentration on Rate Capability at 2C/0.2C for EXAMPLE 1 of the present invention.

FIG. 10 is a graph displaying the effect of PVdF concentration on Rate Capability at 1C/0.2C for EXAMPLE 1 of the present invention.

FIG. 11 is a graph displaying the effect of PVdF concentration on Rate Capability at 2C/0.2C for EXAMPLE 1 of the present invention.

FIG. 12 is a graph displaying Capacity Retention as a function of Polymer Concentration for EXAMPLE 2 of the present invention.

FIG. 13 is a graph displaying Rate Capability at 1C/0.2C as a function of Amount of γBL for Example 2 of the present invention.

FIG. 14 is a graph displaying Rate Capability at 2C/0.2C as a function of Amount of γBL for Example 2 of the present invention.

FIG. 15 is a graph displaying Capacity Retention as a function of Resistance for Example 2 of the present invention.

### DETAILED DESCRIPTION OF THE PREFERRED EMBODIMENT

While this invention is susceptible of embodiment in many different forms, there is shown in the drawings and will be described in detail, several specific embodiments with the understanding that the present disclosure is to be considered as an exemplification of the principles of the invention and is not intended to limit the invention to the embodiments illustrated.

The adhesive-treated separator and method of adhering the electrode to the separator of the present invention enable the formation of liquid electrolyte electrochemical cells having numerous improvements over the known art. Known electrochemical cells having porous separator material require the pores of the separator to be filled with a liquid electrolyte (non-adhesive) or a polymer electrolyte (adhesive) so as to provide ionic conductivity. However, when a polymer electrolyte is used, although the electrodes adhere to the separator, the filling of the pores of the separator results in a reduced battery performance because the ionic conductivity of the gel-polymer filling the pores of the separator is less than the ionic conductivity of the liquid electrolyte typically used. Thus, the resistance of the battery is increased and consequently its performance reduced.

When a liquid electrolyte is used, the electrodes do not adhere to the separator membrane thus requiring an additional and external means to press the electrodes onto the separator membrane in order to maintain continuous low ionic resistance.

The present invention includes an adhesive formulation coated on a separator which when used in the fabrication of electrochemical cells substantially prevents the separator pores from being occluded, unlike any electrochemical cell known in the prior art, while providing sufficient adhesion and contact between the electrodes and the separator membrane in order to provide sufficient ionic conductivity without the need of an external mean to press the electrodes onto the separator membrane.

By precluding occlusion of the pores, using a thin separator membrane, and reducing the amount of adhesive needed to adhere an electrode to the separator, the present invention can produce laminated electrochemical cells having lower rates of mechanical and thermal deformations, closer contact of the separator and electrode, lower electrical resistance, and increased performance. Further, the resulting laminates are easily foldable and configurable, which significantly increases the number of configurations into which the battery can be manufactured.

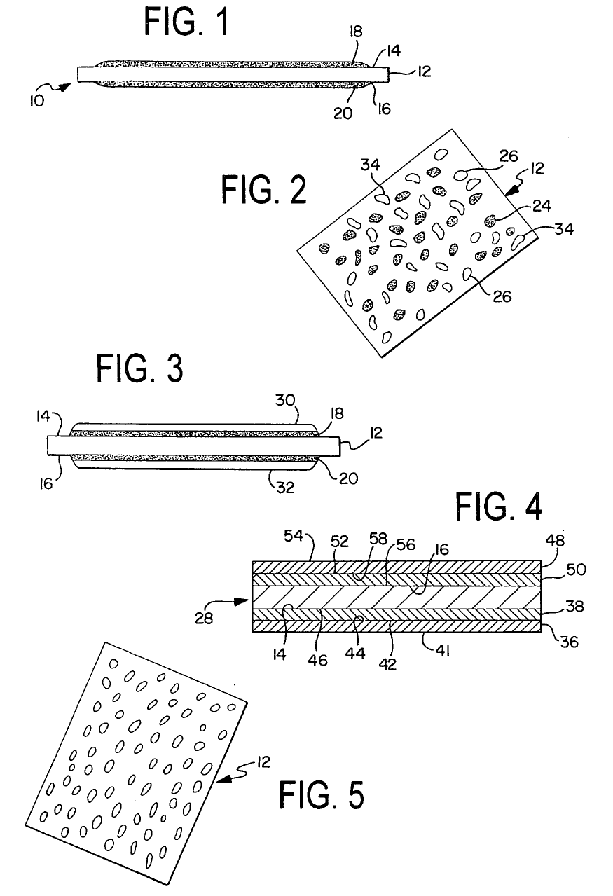

Adhesive-treated separator membrane 10 is shown generally in FIG. 1 as having a porous separator 12 having anode side 14 and cathode side 16. First adhesive formulation 18 is coated on anode side 14. Second adhesive formulation 20 is coated on cathode side 16. The separator is preferably formed from a polyolefin material, but may be any other material which will provide a thin, porous membrane capable of separating charged components.

The first adhesive component and the second adhesive component each include an adhesive component, a solvent, and an occlusion prevention component. It is contemplated that first adhesive formulation 18 and second adhesive formulation 20 may be substantially of the same composition or alternatively may be of different compositions to optimize the differing requirements for securing an anode and a cathode to separator 12. Additionally, the first and second adhesive formulations may have a substantially similar or different coating thickness on the separator. The adhesive formulations 18 and 20 preferably do not include ionic conducting polymer electrolytes, but are preferably formulated to promote adhesion of an electrode to a separator.

The adhesive is preferably selected from the group consisting of poly(ethylene-co-methyl-acrylate), poly(methyl methacrylate), polyethylene oxide, polyvinylidene fluoride, and a polyvinylidene fluoride-hexafluoropropene combination, and preferably, poly(ethylene-co-methyl-acrylate) and polyvinylidene fluoride. Optionally, any other polymer which promotes adhesion between two substrates may be used. Preferably, the concentration of the adhesive component in each of the first and second adhesive formulations is in the range of 1-3 wt %. In one embodiment, either or both of the first and second formulations include at least two different adhesive components, wherein one adhesive especially promotes adhesion of the electrolyte to the separator, while the other adhesive especially promotes ionic conductivity.

The solvent is preferably acetone or Tetrahydrofuran (THF).

Preferably, the adhesive is substantially soluble in the solvent so as to precipitate the adhesive component onto a surface of the separator as the solvent is evaporated.

In one embodiment, the solvent is selected to enhance the wetting of the separator to optimize electrolyte permeation into the pores 26 of the separator. In another embodiment, the solvent is selected for its poor wetting properties so as to limit penetration of the solvent into the pores of the separator.

Occlusion prevention component 24 is shown in FIG. 2 filling pores 26 of separator 12. Preferably, the occlusion prevention component is selected from the group consisting of γBL (gamma butyrolactone), diethyl carbonate, dimethyl carbonate, ethylene carbonate, and propylene carbonate. In a preferred embodiment, the occlusion prevention component is a solid at ambient temperature and has a melting point in the range of 20-30° C. such that it can easily melt into a liquid state when desired during fabrication of a battery cell. The occlusion prevention component comprises the bulk of the composition of the first and second formulations, and preferably is approximately eighty weight-percent of the adhesive formulations (adhesive formulation is the polymer fraction plus the occlusion component, without the solvent).

In yet another embodiment, the occlusion prevention component is a liquid at ambient temperature and may include a liquid selected from the group consisting of γBL, diethyl carbonate, dimethyl carbonate, and propylene carbonate. The occlusion prevention component is preferably substantially soluble or miscible in the solvent and the adhesive component is preferably insoluble into the occlusion preventing component so as to precipitate onto a surface of the separator as the solvent is evaporated.

Additionally, first adhesive formulation 18 and second adhesive formulation 20 may include a performance enhancing agent such as 1,6-spirodilactone and succinic anhydride which promote the prevention of gas formation at the anode during battery use.

Adhesive-treated separator 10 as discussed above may be included as part of a lithium ion liquid electrolyte electrochemical cell 28 as shown in FIG. 3. Cell 28 includes adhesive-treated separator 12, anode 30, cathode 32, and a liquid electrolyte (not shown). The liquid electrolyte preferably includes a lithium salt selected from the group consisting of LiPF6, LiAsF6, LiClO4 and LiBF4. In one embodiment, the occlusion prevention component of the first and second formulations 18, 20 of the adhesive-treated separator are chemically and electrochemically inert with respect to the electrochemical cell. In another embodiment, the occlusion prevention component mixes to become a component usable in the electrochemical cell such as a lithium ion liquid electrolyte.

Due to the fact that the electrodes and separator are adhered together, thus maintaining proper registration of the anode/separator/cathode components, cells fabricated in accordance with the present invention can be laminated and formed into a free form cell having any desirable shape, such as a zig-zag formation, any polygonal shape, or any prismatic form. Additionally, due to substantial lack of occlusions in the porous separator, the electrochemical cell may have a capacity ratio of 0.88-0.96 at 1C/0.2C and a capacity ratio of 0.71-0.86 at 2C/0.2C. Further, the resulting electrochemical cell may have an internal resistance of less than 40 ohms².

FIG. 4 shows a cross-section of cell 28. In the cell, anode 14 includes anode current collector 36 and anode active material 38. The anode current collector includes upper surface 40 and lower surface 42. The anode current collector may comprise a metal such as copper or the like. Anode active material 38 includes upper surface 44 and lower surface 46. Separator 12 includes anode surface 14 and cathode surface 16. Cathode comprises cathode current collector 48 and cathode active material 50. Cathode current collector 48 includes upper surface 52 and lower surface 54. Cathode active material 50 includes upper surface 56 and lower surface 58. The cathode current collector may comprise a conductive metal, such as aluminum or the like. The anode, cathode and current collector may comprise any number of different conventional and proprietary materials.

The cell is configured such that anode surface 14 of separator 12 is associated with lower surface 46 of anode active material 38, and cathode surface 16 of separator 12 is associated with upper surface 56 of cathode active material 50. Lower surface 46 is preferably associated with anode surface 14 and upper surface 56 is preferably associated with cathode surface 16 via first adhesive formulation 18 and second adhesive formulation 20 respectively. In addition, the respective active material and current collector are coextent (i.e., they overlie each other and have substantially the same surface area). In turn, upper surface 44 of anode active material 38 is associated with lower surface 42 of anode current collector 36. Similarly, lower surface 58 of cathode active material 50 is associated with upper surface 52 of cathode current collector 48.

In operation, an anode and a cathode may be adhered to the adhesive-treated separator by the following steps. First, first adhesive formulation 18 is first coated on an anode surface 14 of separator 12 and second adhesive formulation 20 is coated on cathode surface 16 of separator 12 as shown in FIG. 1. The coating may be done by spraying, dip coating, micro-gravure, or via any other suitable means. When applied, occlusion prevention component 24 substantially occupies the volume of the pores 26 of the separator as shown in FIG. 2. The insoluble adhesive component of first adhesive formulation 18 and second adhesive formulation 20 is thus substantially prohibited from entering pores 26 of the separator and is substantially maintained on anode surface 14 and cathode surface 16 where it is in an enhanced position to enable adhesion of anode 30 and cathode 32 to separator 12.

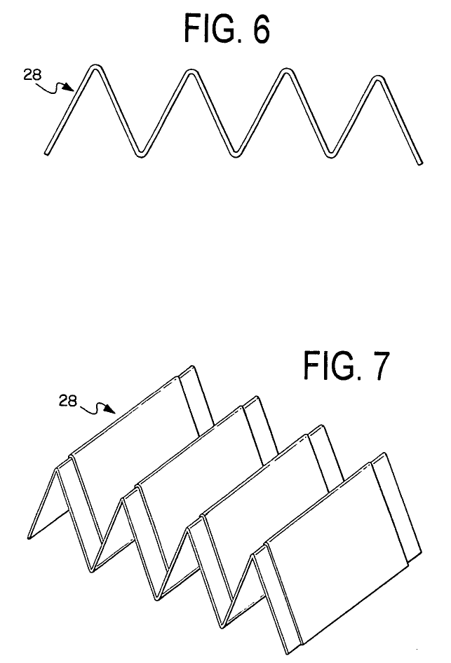

Anode 30 is then placed on anode surface 14 of the separator and cathode 32 is placed on cathode surface 16 of the separator as shown in FIG. 3. The electrodes and separator are preferably heat/pressure laminated at a temperature above which the adhesive component and occlusion preventing component become adhesive (tacky) but not liquid (so that the adhesive component can not flow into the pores) such that the pores 36 of separator 16 are substantially free of occlusions as shown in FIG. 5. By preventing the clogging of the separator pores, the efficiency of the battery cell is vastly increased. Specifically, significantly reducing the number of occlusions increases cell efficiency because of the improved flow of ionic current from the anode to the cathode and vice-versa. While the occlusion prevention component is preferably melted during the lamination step, it is contemplated that the occlusion prevention component may be melted or evaporated prior to lamination.

Once the anode and cathode are laminated, it is contemplated that the liquid electrolyte can then be introduced to the battery system by soaking the laminate in the liquid electrolyte and vacuum packing the liquid electrolyte into the battery via a vacuum or any other suitable means. In another embodiment, it is contemplated that the occlusion prevention component also includes an electrolyte component which dissolves into a liquid electrolyte component usable in the battery system.

In addition to the increased efficiency of the battery, the present invention reduces the amount of adhesive necessary to adhere each electrode to the separator because the solid occlusion component fills the separator pores and forces the adhesive to the surface of the separator. Further, the adhesive is formulated to minimize the level of pressure and temperature under which the lamination is performed. This, in turn, reduces the amount of thermal and mechanical stresses induced in the laminate, thus reducing the total amount of deformation. The resulting laminate is straight, thin, and thus easy to fold. Specifically, these batteries can be formed into a number of desirable shapes which maximize the utilization of the available space for the battery system. For example, the battery 28 having anode 30, cathode 32 and adhesive-treated separator may be formed into a zig-zag (accordion fold) as shown in FIGS. 6-7.

The following examples demonstrate the increased efficiency of a battery system using the adhesive formulation and method of adhering of the present invention:

### EXAMPLE 1

Different concentration of PEO (polyethylene oxide) and PVdF (polyvinylidene fluoride) solutions were prepared as given in Table 1. As seen in Table 1, PEO and PVdF concentrations investigated in this work are in range from 1-3 wt %. Solutions that were opaque were stirred on hot plate until turn clear.

TABLE 1
PEO (polyethylene oxide) and PVdF
(polyvinylidene fluoride) Solutions

| Polymer Solution | Opacity |
|---|---|
| 1% w/w PEO in γBL | Clear |
| 2% w/w PEO in γBL | Clear |
| 3% w/w PEO in γBL | Opaque |
| 1% w/w PEO in EC:DMC = 3:7 w/w | Clear |
| 2% w/w PEO in EC:DMC = 3:7 w/w | Opaque |
| 3% w/w PEO in EC:DMC = 3:7 w/w | Opaque |
| 1% w/w Kynar 2801 in γBL | Clear |
| 2% w/w Kynar 2801 in γBL | Clear |
| 3% w/w Kynar 2801 in γBL | Clear |
| 1% w/w Kynar 2801 in EC:DMC = 3:7 w/w | Clear |
| 2% w/w Kynar 2801 in EC:DMC = 3:7 w/w | Clear |
| 3% w/w Kynar 2801 in EC:DMC = 3:7 w/w | Clear |

Polymer solutions were sprayed on electrodes of area 41.76 cm2 by using an airbrush. A strip of Celgard 2500 as a separator was placed in between two electrodes. Lamination was achieved by passing the assembled stack through laminator at approximately 110° C. Two cells were assembled for each polymer solution.

Electrodes used were cathode: PL50(761A), 88-6-6 and anode: QC4100 (Kynar 761A), 91-3-6.

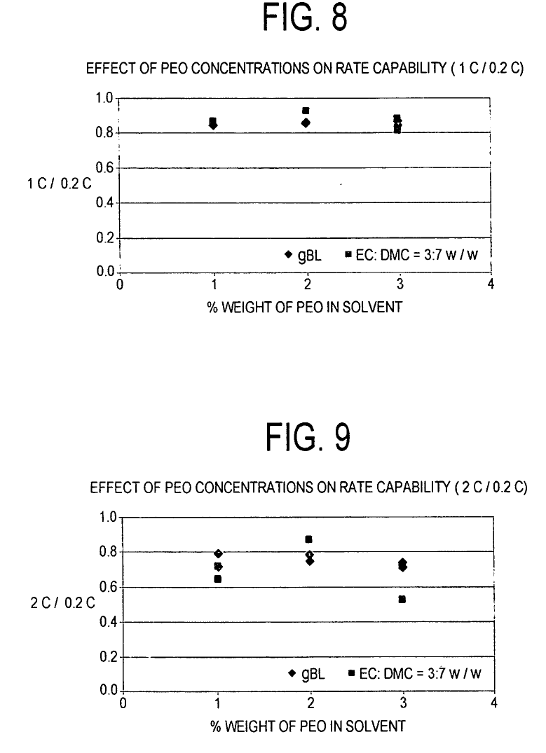

FIGS. 7-8 show rate capability, expressed as ratio of capacity at 1C and 0.2 C discharge rate and capacity at 2C and 0.2 C discharge rate, as a function of PEO concentration in γBL and EC/DEC (3:7 wt).

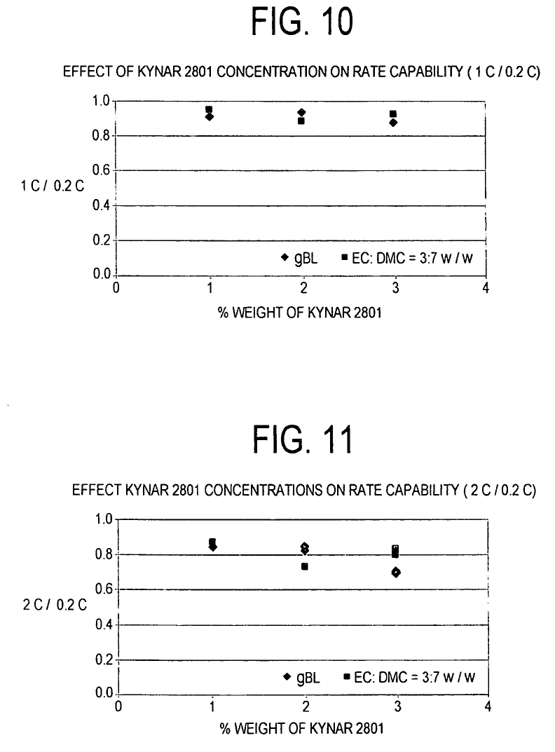

Similarly, FIGS. 9-10 illustrate the same relationship of capacity at 1C and 0.2 C discharge rate and capacity at 2C and 0.2 C discharge rate as a function of PVdF concentration. As can be seen from both figures, there is no dramatic effect of polymer concentration on rate behavior. However, it seems that with respect to PEO solutions, the best performance in terms of rate capability is achieved with 2 wt % solution. In the case of PVdF, there is slight trend of lowering rate capability by increase in PVdF concentration. In general, better rate behavior was achieved in cells laminated using PVdF: 1C/0.2C=0.88-0.96% for PVdF laminated cells in comparison to 0.82-0.94 for PEO laminated cells; also capacity ratio at 2C/0.2C =0.71-0.86 for PVdF laminated cells in comparison to 0.60-0.84 for PEO laminated cells.

There is no obvious difference in using γBL and EC: DEC solvents. However, it was noticed that adhesion was better when γBL was used as a solvent.

Higher cell resistance leads to lower rate capability. However, there is no obvious reason why cells vary in resistance, i.e. there is no strong relationship in between concentration of the polymer (PEO or PVdF) and resistance (see FIG. 11) The discharge capacity retention, expressed as a ratio of discharge capacity in cycle 30 to discharge capacity in cycle 5, as a function of polymer concentration, is shown in FIG. 11. As seen from the graph the capacity retention was found to be approximately constant in the investigated polymer concentration range.

The effect of cell lamination with 1, 2 and 3 wt % solutions of PEO and PVdF in γBL and EC: DEC (3:7 wt) on electrochemical characteristics of the cell was examined. It was found that rate behavior of the cell is dependent on cell internal resistance and impedance. It was found no particular relationship in between polymer concentration (in this concentration range) and either rate capability or capacity retention on cycling.

Lamination using PVdF solutions gives slightly better cell performance in comparison with PEO solutions. Using γBL as a solvent gives better adhesion then EC: DEC (3:7 wt %) (by visual judgment) although the electrochemical data show no clear difference.

From these observations, it is concluded that an adhesive layer can be coated on a porous electrode in order to increase it adhesive properties without compromising battery performance.

### EXAMPLE 2

Instead of coating an adhesive on the electrodes, a solvent is coated on the electrode in order to soften the polymer binder in the electrode and to make it adhesive.

Electrodes used in the experiments were cathode: PL50(761A), 88-6-6 and anode: QC4100 (Kynar 761A), 91-3-6. The electrodes active area was 41.76 cm2 (‘3 strips’).

Different amounts of γBL were sprayed on the electrodes using an air-brush. Special attention was given to the uniformity of spraying, which covered the electrode as well as would be achieved by hand air-brushing. Each electrode was weighted before and immediately after applying the solvent. Table 2 gives the amounts of the solvent applied. A strip of Celgard 2500 as a separator was placed in between two electrodes, and lamination was achieved by passing the assembled stack through a laminator at ˜110 C.

After overnight vacuum drying, the activation of the cells was done in a glove box by soaking the cells in an excess of electrolyte (SR40-1) for 1 hour. Excess electrolyte was removed and the cells were vacuum packed. The cells were tested electrochemically.

TABLE 2
Amount of γBL air brushed on the electrodes.

| | γBL air-brushed | γBL air-brushed on |
|---|---|---|
| Cell name | on anode, g | cathode, g |
| GBag181 | 0.3647 | 0.441 |
| GBag182 | 0.2436 | 0.3294 |
| GBag183 | 0.8211 | 0.2691 |
| GBag184 | 0.2089 | 0.287 |
| GBag185 | 0.285 | 0.3571 |
| GBag186 | 0.2841 | 0.394 |
| GBag188 | 0.173 | 0.216 |

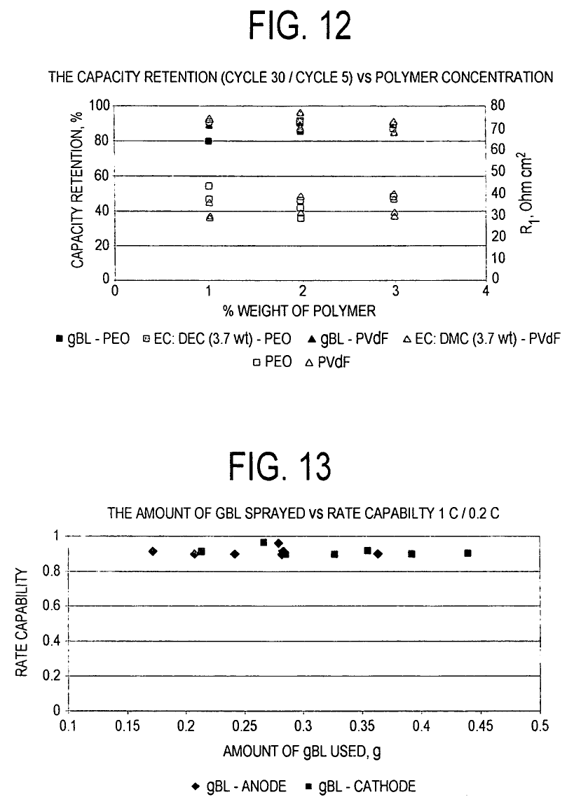

FIGS. 12-13 shows rate capability of the cells, expressed as a discharged capacity ratio at 1C/0.2 C (FIG. 12) and 2C/0.2C (FIG. 13) discharge rate as a function of amount of γBL applied on the electrodes. It can be seen that cell rate capability is basically independent of the amount of applied solvent. The obtained averaged discharge capacity ratio at 1C/0.2C was 91% and at 2C/0.2C was 81%.

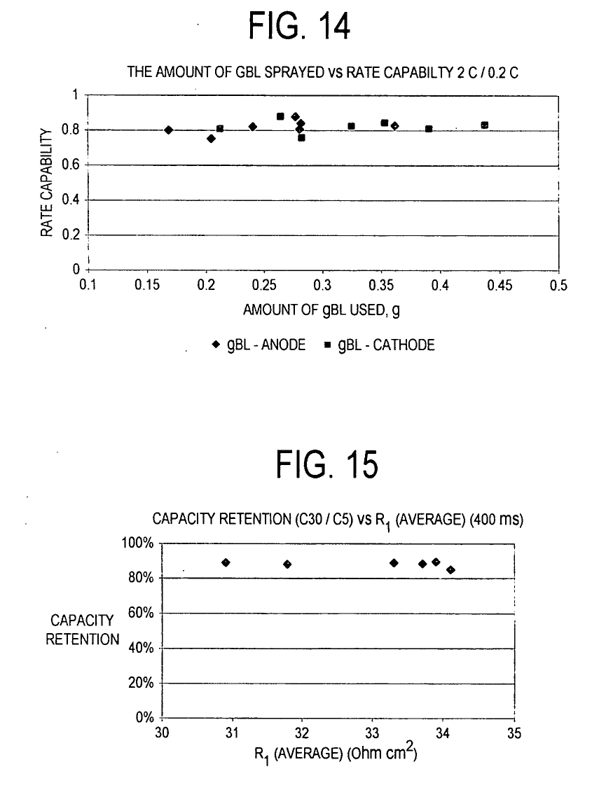

Capacity retention for the cells after 30 cycles, expressed as discharge capacity ratio at cycle 30 to cycle 5 (both discharge rates were 0.5 C), in dependence of internal resistance is shown in FIG. 14. From the presented data it seems that the capacity retention (at least up to cycle 30) is not dependent on cell's internal resistance.

Lamination of the electrodes to the separator by applying γBL on electrodes is an extremely simple laboratory method of cell fabrication. This shows that the electrochemical behavior of the cell is not affected by variations in the amount of applied γBL.

Adhesion was good in all assembled cells.

Several experiments on polymer blends which include PEMA, PMMA, PEO and/or PVDF have been performed and their electrochemical results are presented here.

### EXAMPLE 3

A battery was formed using the following procedure:

1) Prepare a PEMA polymer blend in THF solvent mixture under heating and stirring.
2) Coat Celgard 2500 in PEMA blend solution for 1˜3 minutes and then dry in air.
3) Laminate cathode, coated separator, and anode under lower power setting.
4) Dry in 60° C. oven under vacuum for overnight or more to completely remove THF.
5) Soak lamination stack in electrolyte SR40 for at least 1 hrs.
6) Vacuum sealing into prismatic cells.

It was found:

(a) PEMA dissolves in hot THF, not in NMP, acetone and carbonate solvent such as EC, DEC and DMC;

(b) having high boiling points, γBL, EC and PC were used in solvent mixtures in order to leave pores open in coated separator;

(c) PEMA showed good adhesion between electrodes and separators. No delamination was observed in the cells with PEMA/PEO, PEMA/PMMA blend coated separator after soaking in electrolyte for 2 hrs;

(d) Generally speaking, larger sized prismatic cells showed better electrochemical performance than smaller sized prismatic cells;

(e) Cells of separator coated with PEMA/PEO, PEMA/PMMA blend show low internal resistance of less than 40 Ohms cm², but unexpected cells of separator coated with PEMA/PVdF blend show very high resistance;

(f) Cells of separator coated with PEO or PMMA in PEMA blend showed similar electrochemical performance;

(g) Cells which EC, γBL and PC in solvent mixture for PEMA blend coated separator showed similar electrochemical performance; and

(h) Discharge capacities of prismatic cells were stable with cycle number and their rate performance was reasonable good.

### EXAMPLE 4

The following presents a best mode for the fabrication of the electrodes-separator laminate. There is disclosed below a sequence of the lamination, the conditions under which the lamination is performed, and the preparation of the electrodes and the separator components prior to the lamination and resulting combined effect of these conditions.

The disclosed sequence of lamination enables the fabrication of laminates that have a high level of registration, i.e., the separator and electrodes remain straight, and have a minimum level of mechanical or thermal induced deformation.

Multiple Patches Electrode Lamination:

A belt laminator was used under the following operating conditions:

(a) heating zones set at 96 C

(b) Gap between nip rolls at 25 micron

(c) Gauge force on laminating roll set at 25 KGF left and right

Cathode and Separator Lamination

1. Straighten and flatten prepared cathode strip on carrier belt;

2. Apply the adhesive separator on the top of the anode while maintaining an interleaf on the top of the adhesive separator, and feed into belt laminator

Addition of Anode Strip to Lamination

1. Remove separator interleaf sheet;

2. Align pre-cut anode strip on the top of the adhesive separator-cathode laminate and feed into belt laminator.

Quality Checks

1. Check lamination for defects, i.e. metal whiskers, hairs, delaminated electrode areas

2. Lamination should be straight (bowing ≦1.5 mm over 1000 mm) and in registration (out of registration ≦0.5 mm).

The above examples demonstrate that adhesion of an electrode to a porous separator membrane via the adhesive-treated separator membrane of the present invention and the disclosed method of adhering an electrode to a porous separator via the adhesive treated separator membrane provide a useful means to fabricate free form batteries having without compromising electrochemical performance.

While specific embodiments have been illustrated and described herein, numerous modifications may come to mind to one of ordinary skill in the relevant art without significantly departing from the spirit of the invention, and the scope of protection is only limited by the scope of the accompanying Claims.

1. An adhesive-treated separator membrane in a lithium ion liquid electrolyte battery system, comprising:
a porous separator having an anode side and a cathode side;
a first adhesive formulation coated on the anode side; and
a second adhesive formulation coated on the cathode side;
wherein the first and second formulation each include an adhesive component and an occlusion prevention component

2. The adhesive-treated separator membrane according to claim 1, wherein the adhesive component is selected from the group consisting of poly(ethylene-co-methyl-acrylate), poly(methyl methacrylate), polyethylene oxide, polyvinylidene fluoride, and polyvinylidene fluoride-hexafluoropropene.

3. The adhesive-treated separator membrane according to claim 1, wherein the adhesive formulation contains between one and three weight-percent of the adhesive component.

4. The adhesive-treated separator membrane according to claim 1, wherein the adhesive component comprises at least two adhesive components selected from the group consisting of poly(ethylene-co-methyl-acrylate), poly(methyl methacrylate), polyethylene oxide, polyvinylidene fluoride, and polyvinylidene fluoride-hexafluoropropene, wherein one polymer promotes adhesion of the electrolyte to the separator and the other promotes ionic conductivity.

5. The adhesive-treated separator membrane according to claim 1, wherein a solvent is utilized in the adhesive formulations during coating of the separator, the solvent selected from the group consisting of acetone, γBL, diethyl carbonate, dimethyl carbonate, ethylene carbonate, propylene carbonate, and tetrahydrofuran (THF).

6. The adhesive-treated separator membrane according to claim 5, wherein the adhesive component is substantially insoluble in the solvent.

7. The adhesive-treated separator membrane according to claim 5, wherein the adhesive component is substantially soluble in the solvent.

8. The adhesive-treated separator membrane according to claim 1, wherein the adhesive component is soluble in the liquid electrolyte of the battery.

9. The adhesive-treated separator membrane according to claim 1, wherein the adhesive component is insoluble in the liquid electrolyte of the battery.

10. The adhesive-treated separator membrane according to claim 1, wherein the occlusion prevention component is a solid at ambient temperature.

11. The adhesive-treated separator membrane according to claim 10, wherein the occlusion prevention component has a melting point in the range of 20° to 30° C.

12. The adhesive-treated separator membrane according to claim 1, wherein the occlusion prevention component is a liquid at ambient temperature.

13. The adhesive-treated separator membrane according to claim 12, wherein the occlusion prevention component includes a liquid selected from the group consisting of γBL, diethyl carbonate, dimethyl carbonate, ethylene carbonate, propylene carbonate, and tetrahydrofuran (THF).

14. The adhesive-treated separator membrane according to claim 1, wherein at least one of the first and second formulations includes a performance enhancing additive selected from the group consisting of 1,6-spirodilactone and succinic anhydride.

15. The adhesive-treated separator membrane according to claim 1, wherein at least one of the first and second formulations includes a flame retardant component.

16. The adhesive-treated separator membrane according to claim 1, wherein the first and second formulations are of a substantially similar composition.

17. The adhesive-treated separator membrane according to claim 1, wherein the first and second formulations are of a different composition to optimize adhesive properties for each electrode.

18. The adhesive-treated separator membrane according to claim 1, wherein the first and second formulation are of a substantially similar coating thickness.

19. The adhesive-treated separator membrane according to claim 1, wherein the first and second formulation are of a different coating thickness so as to optimize adhesive properties for each electrode.

20. The adhesive-treated separator membrane according to claim 1, wherein the separator is formed from a polyolefin material.

21. An electrochemical cell, comprising:
an adhesive treated separator membrane including
a porous separator having an anode side and a cathode side;
a first adhesive formulation coated on the anode side; and
a second adhesive formulation coated on the cathode side,
wherein the first and second formulation each include an adhesive component and an occlusion prevention component;
an anode associated with the anode side via the first adhesive formulation;
a cathode associated with the cathode side via the second adhesive formulation; and
a liquid electrolyte component to promote ionic conductivity between the anode and electrode.

22. The electrochemical cell according to claim 21, wherein the liquid electrolyte component includes a lithium salt selected from the group consisting of LiPF6, LiClO4, LiAsF6, and LiBF4.

23. The battery system according to claim 21, wherein the occlusion prevention component is chemically and electrochemically inert with respect to the electrochemical cell.

24. The electrochemical cell according to claim 21, wherein the cell can be formed into a free form battery having any desirable shape.

25. The electrochemical cell according to claim 24, wherein the cell can be formed into a battery having a zig-zag or configuration.

26. The battery system according to claim 21, wherein electrochemical cell has a capacity ratio of at least 0.88-0.96 at 1C/0.2C and a capacity ratio of at least 0.71-0.86 at 2C/0.2C.

27. The battery system according to claim 21, wherein the electrochemical cell has an internal resistance of less than 40 ohm/cm².

28. A method for adhering an electrode to a separator in a lithium ion liquid electrolyte battery system comprising the steps of:
providing a first adhesive formulation and a second adhesive formulation, wherein the first and second adhesive formulation each include an adhesive component, a solvent, and an occlusion prevention component;
providing a porous separator having an anode side and a cathode side;
coating the anode side of the separator with the first adhesive formulation and coating the cathode side of the separator with the second adhesive formulation such that the occlusion prevention component substantially plugs the pores of the separator;
precluding occlusions in the pores of the separator so as to substantially free the pores of occlusions; and
laminating an anode to the anode side and a cathode to the cathode side of the separator.

29. The method according to claim 28, wherein the step of coating includes the step of coating via at least one of a spraying, dip coating, and a micro-gravure process.

30. The method according to claim 28, wherein the step of providing a first adhesive formulation and a second adhesive formulation includes the step of providing an adhesive component selected from the group consisting of poly(ethylene-co-methyl-acrylate), poly(methyl methacrylate), polyethylene oxide, polyvinylidene fluoride, and polyvinylidene fluoride-hexafluoropropene.

31. The method according to claim 28, wherein the step of providing a first adhesive formulation and a second adhesive formulation includes the step of providing between one and three weight-percent of the adhesive component.

32. The adhesive-treated separator membrane according to claim 28, wherein the step of providing a first adhesive formulation and a second adhesive formulation includes the step of providing the adhesive component with at least two adhesive components selected from the group consisting of poly(ethylene-co-methyl-acrylate), poly(methyl methacrylate), polyethylene oxide, polyvinylidene fluoride, and polyvinylidene fluoride-hexafluoropropene, wherein one polymer promotes adhesion of the electrolyte to the separator and the other promotes ionic conductivity.

33. The adhesive-treated separator membrane according to claim 28, wherein the step of providing a first adhesive formulation and a second adhesive formulation includes the step of providing a solvent selected from the group consisting of acetone, γBL, diethyl carbonate, dimethyl carbonate, ethylene carbonate, propylene carbonate, and tetrahydrafuran.

34. The method according to claim 28, wherein the step of providing a first adhesive formulation and a second adhesive formulation include the step of providing an occlusion prevention component which is a solid at ambient temperature.

35. The method according to claim 34, wherein the step of providing a first adhesive formulation and a second adhesive formulation includes the step of providing an occlusion prevention component having a melting point in the range of 20° to 30° C.

36. The method according to claim 34, wherein the step of providing a first adhesive formulation and a second adhesive formulation includes the step of providing an occlusion prevention component with a particle size greater than the pore size of the porous separator.

37. The method according to claim 34, wherein the step of precluding occlusions includes the step of melting the occlusion prevention component.

38. The adhesive-treated separator membrane according to claim 28, wherein the occlusion prevention component includes an electrolyte component selected from the group consisting of, LiPF6, LiClO4, LiAsF6, and LiBF4.

39. The method according to claim 28, wherein the step of providing a first adhesive formulation and a second adhesive formulation includes the step of providing an occlusion prevention component is a liquid at ambient temperature.

40. The method according to claim 39, wherein the step of providing an occlusion prevention component is a liquid at ambient temperature includes the step of providing a solvent selected from the group consisting of acetone, γBL, diethyl carbonate, dimethyl carbonate, ethylene carbonate, propylene carbonate, and tetrahydrafuran.

41. The method according to claim 39, wherein the step of precluding occlusions includes the step of evaporating the occlusion prevention component.

42. The method according to claim 28, wherein the step of providing a first adhesive formulation and a second adhesive formulation includes the step of providing the first and second adhesive formulation with a substantially similar composition.

43. The method according to claim 28, wherein the step of providing a first adhesive formulation and a second adhesive formulation includes the step of providing the first and second adhesive formulation with a different composition.

44. The method according to claim 28, wherein the step of providing a first adhesive formulation and a second adhesive formulation includes the step of providing the first and second adhesive formulation with a different composition substantially similar coating thickness.

45. The method according to claim 28, wherein the step of providing a first adhesive formulation and a second adhesive formulation includes the step of providing the first and second adhesive formulation with a different coating thickness.

46. The method according to claim 28, wherein the step of laminating further includes the step of forming an electrochemical cell having a free form geometry.

47. The method according to claim 46, wherein the step of forming an electrochemical cell includes the step of forming a cell having a zig-zag or polygonal shape.
